(19) United States
(12) Patent Application Publication
(10) Pub. No.: US 2023/0160790 A1
(43) Pub. Date: May 25, 2023

(54) BIOLOGICAL SAMPLE DETECTION METHOD BASED ON SURFACE-ENHANCED RAMAN SPECTROSCOPY

(71) Applicant: UNIVERSITY OF HONG KONG SHENZHEN FUTIAN RESEARCH INSTITUTE, SHENZHEN (CN)

(72) Inventors: Jian LU, Shenzhen (CN); Binbin ZHOU, Shenzhen (CN); Junda SHEN, Shenzhen (CN); Zebiao LI, Shenzhen (CN); Yangyang LI, Shenzhen (CN)

(73) Assignee: UNIVERSITY OF HONG KONG SHENZHEN FUTIAN RESEARCH INSTITUTE, SHENZHEN (CN)

(21) Appl. No.: 17/673,070

(22) Filed: Feb. 16, 2022

Related U.S. Application Data
(63) Continuation of application No. PCT/CN2021/135428, filed on Dec. 3, 2021.

(30) Foreign Application Priority Data
Nov. 23, 2021 (CN) 202111398058.2

(51) Int. Cl. G01N 1/28; G01N 21/65

(52) U.S. Cl. CPC G01N 1/2813; G01N 21/658; G01N 2001/2826

(57) ABSTRACT

A biological sample detection method based on surface-enhanced Raman spectroscopy is disclosed, which relates to the technical field of biological detection. The method includes following operations: washing a substrate used for Raman spectroscopy to obtain a clean substrate; performing surface nanostructuring on the clean substrate to make the clean substrate have a surface Raman enhancement effect, and ultrasonically cleaning the nanostructured substrate with clear water to obtain a surface nanostructured substrate; and inserting the surface nanostructured substrate in a test biological sample, and taking it out after adsorbing the substance to be detected, and then detecting Raman spectrum signals on the surface.

### CROSS-REFERENCE TO RELATED APPLICATIONS

This application is a continuation application of PCT Application No. PCT/CN2021/135428, filed on Dec. 3, 2021, which claims priority to Chinese Patent

Application No. 202111398058.2, filed on Nov. 23, 2021, the entire disclosure of which are incorporated herein by reference.

### TECHNICAL FIELD

The present disclosure relates to the technical field of biological detection, and in particular to a biological sample detection method based on surface-enhanced Raman spectroscopy.

### BACKGROUND

Surface-enhanced Raman spectroscopy (SERS) can be used for direct detection of urine, saliva, blood or tissue due to its high sensitivity, easy operation, and no damage, which is expected to become a new home diagnostic technology to determine health through spectral detection.

However, the currently used sol SERS substrate is very easy to agglomerate in complicated biological samples such as urine, saliva, blood, or the like, resulting in the lack of Raman signal. Another substrate with nanoparticles deposited on silicon wafers is easy to adsorb proteins in biological samples, resulting in inactivation of the substrate. Neither of the two currently common commercial SERS substrates can directly detect biological samples such as urine, saliva, and blood. It is necessary, for detection of biological sample using current commercial SERS substrate, to first remove the protein in the biological sample by adding organic solvents and centrifugation, and then perform the detection, and all the current commercial SERS substrates cannot detect the inside of the tissue. Obviously, the complex operation and limited detection range of existing commercial substrates cannot meet the needs of household use.

### SUMMARY

The main objective of the present disclosure is to provide a biological sample detection method based on surface-enhanced Raman spectroscopy, aiming to provide a simple and convenient biological sample detection method based on surface-enhanced Raman spectroscopy.

In order to achieve the above objective, the present disclosure provides a biological sample detection method based on surface-enhanced Raman spectroscopy, including the following operations:

washing the substrate used for Raman spectroscopy to obtain a clean substrate;

performing surface nanostructuring on the clean substrate to make the clean substrate have a surface Raman enhancement effect, and ultrasonically cleaning the nanostructured substrate with clear water to obtain a surface nanostructured substrate; and

inserting the surface nanostructured substrate in a test biological sample, and taking it out after adsorbing the substance to be detected, and detecting Raman spectrum signals on the substrate surface.

In an embodiment, the substrate is made of any one of silver, gold and copper.

In an embodiment, the operation of performing surface nanostructuring on the clean substrate includes:

etching the surface of the clean substrate with acid, so that the surface has a nanostructure with Raman spectrum enhancement effect to complete the surface nano structuring.

In an embodiment, an etching solution includes any one of nitric acid, sulfuric acid and hydrochloric acid.

In an embodiment, the etching solution includes nitric acid, and the concentration of the nitric acid is 0.1 mol/L to 1 mol/L.

In an embodiment, the operation of performing surface nanostructuring on the clean substrate includes:

placing the clean substrate in an electrolytic cell, and alternately supplying positive and negative currents, so that the surface of the clean substrate has a nanostructure with Raman spectrum enhancement effect, achieving the surface nanostructuring.

In an embodiment, the substrate is made of any one of stainless steel, iron, glass and quartz,

the operation of performing surface nanostructuring on the clean substrate includes:

modifying gold nanoparticle or silver nanoparticle on the surface of the clean substrate, so that the surface of the clean substrate has a nanostructure with Raman spectrum enhancement effect, achieving the surface nanostructuring.

In an embodiment, the time for the surface nanostructured substrate to be placed in the test biological sample is around 1 second to 600 seconds.

In an embodiment, the biological sample includes one of urine, saliva, tears, blood, serum, plasma, sweat, and semen.

In an embodiment, the biological sample includes melanoma or subcutaneous tissue.

In technical solutions of the present disclosure, the clean substrate with surface Raman enhancement effect was produced by performing surface nanostructuring on the substrate. The nanostructured substrate can be directly inserted into the biological sample to adsorb small molecules in the biological sample. The movement of small molecules is faster than that of proteins, and the nanostructured substrate is also easier to adsorb small molecules. As such, the adsorption time of the substrate in the biological sample can be controlled, and the adsorption and sedimentation of protein can be avoided, thereby realizing rapid and reproducible detection of biological samples. The present disclosure provides a biological sample detection method based on surface-enhanced Raman spectroscopy, which can be directly inserted into the biological sample for detection. The biological sample does not need to be processed for protein removal, which simplifies the operation process and expands the scope of application. Thus, it is possible to avoid the influence of protein adsorption to enhance the sensitivity and stability of the substrate without pre-processing, and obtain stable and repeatable Raman signals of various biological samples in a short time.

### BRIEF DESCRIPTION OF THE DRAWINGS

In order to more clearly illustrate the embodiments of the present disclosure, drawings used in the embodiments will be briefly described below. Obviously, the drawings in the following description are only some embodiments of the present disclosure. It will be apparent to those skilled in the field that other drawings can be obtained according to the structures shown in the drawings without creative work.

FIG. 1 is an optical photograph of a silver needle, electron microscope photographs of a clean substrate and a surface nanostructured substrate in Example 1 of the present disclosure.

FIG. 2 is an elemental analysis diagram of the clean substrate in Example 1 of the present disclosure.

FIG. 3 is a process diagram of operation (3) in Example 1 of the present disclosure.

FIG. 4 is a detection result diagram of surface-enhanced Raman spectroscopy in Example 1 of the present disclosure.

FIG. 5 is a detection process diagram of Example 1 and the comparative example of the present disclosure.

FIG. 6 is a detection result diagram of surface-enhanced Raman spectroscopy of Example 1 and the comparative example of the present disclosure.

The realization of the objective, functional characteristics and advantages of the present disclosure are further described by combining with the embodiment and referring to the accompanying drawings.

### DETAILED DESCRIPTION OF THE EMBODIMENTS

The technical solutions of the embodiments of the present disclosure will be described clearly and completely as follow in combination with the accompanying drawings. It is obvious that the embodiments to be described are only some rather than all of the embodiments of the present disclosure. All other embodiments obtained by persons skilled in the field based on the embodiments of the present disclosure without creative efforts shall fall within the scope of the present disclosure.

It should be noted that if there is a directional indication (such as up, down, left, right, front, rear . . . ) in the embodiments of the present disclosure, the directional indication is only used to explain the relative positional relationship, movement situation, etc. of the components in a certain posture (as shown in the drawings). If the specific posture changes, the directional indication will change accordingly.

In addition, the descriptions associated with, e.g., “first” and “second” in the present disclosure are merely for descriptive purposes, and cannot be understood as indicating or suggesting relative importance or impliedly indicating the number of the indicated technical feature. Therefore, the feature associated with “first” or “second” can expressly or impliedly include at least one such feature. Besides, the meaning of “and/or” appearing in the disclosure includes three parallel scenarios. For example, “A and/or B” includes only A, or only B, or both A and B. The technical solutions between the various embodiments can be combined with each other, but they must be based on what can be implemented by those of ordinary skilled in the field. When the combination of technical solutions is contradictory or cannot be achieved, it should be considered that such a combination of technical solutions does not exist, nor is it within the scope of the present disclosure.

Surface-enhanced Raman spectroscopy (SERS) can be used for direct detection of urine, saliva, blood or tissue due to its high sensitivity, easy operation, and no damage, which is expected to become a new home diagnostic technology to judge health condition through spectral detection.

However, the currently used sol surface-enhanced Raman spectroscopy substrate is very easy to agglomerate in complicated biological samples such as urine, saliva, blood, etc., resulting in the lack of Raman signal. Another substrate with nanoparticles deposited on silicon wafers is easy to adsorb proteins in biological samples, resulting in inactivation of the substrate. Neither of the two currently common commercial surface-enhanced Raman spectroscopy can directly detect biological samples such as urine, saliva, and blood. It is necessary to first remove the protein in the biological sample by adding organic solvents and centrifugation, and then perform the detection, and all the current commercial surface-enhanced Raman spectroscopy substrates cannot detect the inside of the tissue. Obviously, the complex operation and limited detection range of existing commercial substrates cannot meet the needs of household use.

In view of this, the present disclosure provides a biological sample detection method based on surface-enhanced Raman spectroscopy, aiming to provide a simple and convenient biological sample detection method based on surface-enhanced Raman spectroscopy.

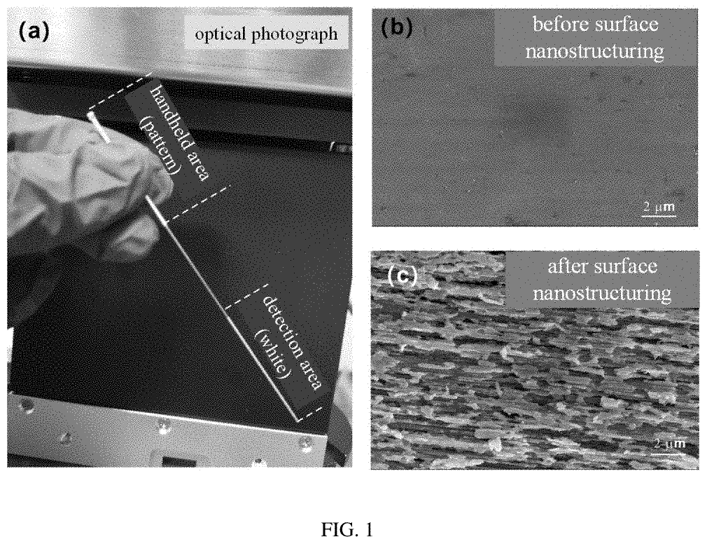

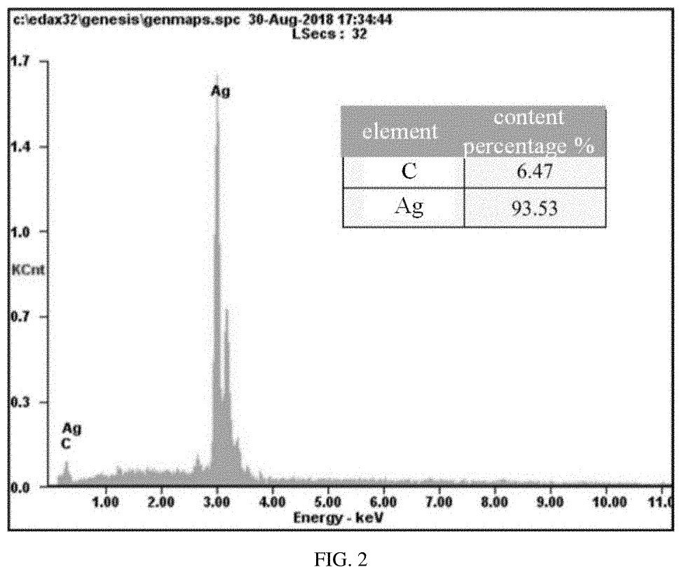

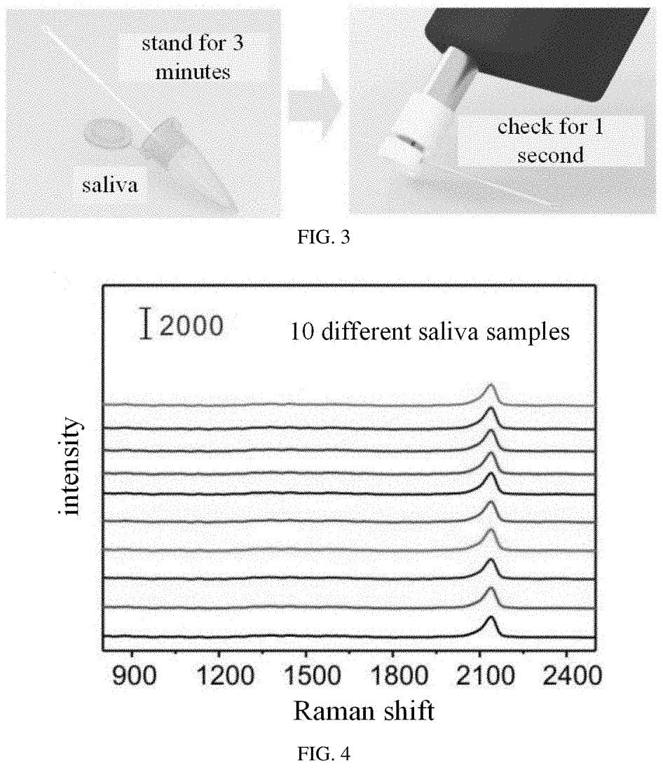

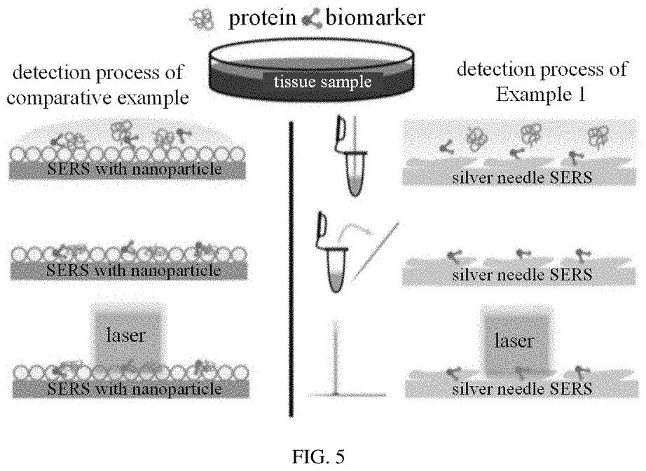

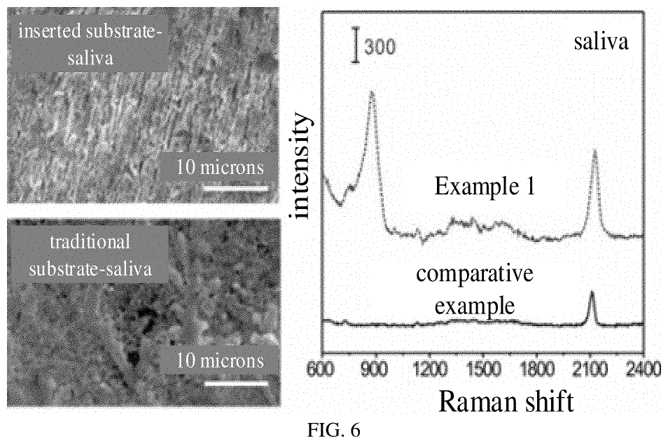

In the drawings of the present disclosure, FIG. 1 is an optical photograph of a silver needle, electron microscope photographs of the clean substrate and the surface nanostructured substrate in Example 1 of the present disclosure. FIG. 2 is an elemental analysis diagram of the clean substrate in Example 1 of the present disclosure. FIG. 3 is a process diagram of operation (3) in Example 1 of the present disclosure. FIG. 4 is a detection result diagram of surface-enhanced Raman spectroscopy in Example 1 of the present disclosure. FIG. 5 is a detection process diagram of Example 1 and the comparative example of the present disclosure. FIG. 6 is a detection result diagram of surface-enhanced Raman spectroscopy of Example 1 and the comparative example of the present disclosure.

The present disclosure provides a biological sample detection method based on surface-enhanced Raman spectroscopy, including the following operations:

Operation S10, washing a substrate used for Raman spectroscopy to obtain a clean substrate.

In this embodiment, the substrate is pre-treated to remove impurities on the surface of the substrate and activate the substrate. The material of the substrate is not limited in the present disclosure, which can be any one of silver, gold, copper, stainless steel, iron, glass and quartz. It should be noted that when the substrate is made of stainless steel, iron, glass, and quartz, a layer of gold, silver or copper needs to be plated on the surface of the substrate.

Preferably, the substrate can be made of any one of silver, gold, and copper, and the detection result is more accurate by using the above-mentioned precious metal.

In an embodiment of the present disclosure, it is possible to alternate ultrasonic cleaning with acetone and ethanol to clean the substrate, that is, after ultrasonic cleaning with acetone, then ultrasonic cleaning with ethanol, and then repeat the above cleaning. The number of times for alternating ultrasonic cleaning with acetone and ethanol is not limited in the present disclosure. In theory, the more the better. In the embodiment of the present disclosure, the substrates are alternately ultrasonically cleaned with acetone and ethanol for three times, which can basically meet the cleaning requirements.

The shape of the substrate is not limited in the present disclosure. Silver is taken as an example, which can be silver flakes, silver wires, silver needles, or the like, and can be selected according to the state of the biological sample to be detected. If the biological sample to be detected is liquid, the above-mentioned shapes can be used. If the biological sample to be detected is solid, silver needles can be used.

Operation S20, performing surface nanostructuring on the clean substrate to achieve the nanostructured substrate with surface Raman enhancement effect, and then ultrasonically cleaning the nanostructured substrate with clear water to obtain a surface nanostructured substrate.

In this operation, the surface nanostructuring is performed on the surface of the clean substrate. The method of surface nanostructuring is not limited in the present disclosure.

In a first embodiment of the present disclosure, the surface of the clean substrate is chemically etched. Specifically, the operation of performing surface nanostructuring on the surface of the clean substrate includes:

etching the surface of the clean substrate with acid, so that the surface has a nanostructure with Raman spectrum enhancement effect to complete the surface nanostructuring. Chemical etching can increase the roughness of the clean substrate surface, which is conducive to the faster absorption of small molecules. The present disclosure does not limit the type of the acid. Preferably, the etching solution includes any one of nitric acid, sulfuric acid, and hydrochloric acid. Using any one of the above-mentioned acids, the surface nanostructuring effect is better.

More preferably, the etching solution includes nitric acid, and the concentration of the nitric acid is 0.1 mol/L to 1 mol/L. Experiments show that the etching effect is good when the above-mentioned concentration of nitric acid is used as the etching solution.

In a second embodiment of the present disclosure, electrochemical etching and deposition are used to perform the surface nanostructuring on the surface of the clean substrate. Specifically, the operation of performing surface nanostructuring on the surface of the clean substrate includes:

placing the clean substrate in an electrolytic cell, and alternately supplying positive and negative currents, so that the surface of the clean substrate has a nanostructure with Raman spectrum enhancement effect to complete the surface nanostructuring of the clean substrate. The silver needle is taken as an example. The silver needle is placed in the electrolytic cell and treated with a positive current +0.05 A for 5 seconds to etch the silver and some impurities (such as a small amount of copper) on the surface of the silver needle; then treated with a negative current −0.05 A for 5 seconds to precipitate the silver in the electrolyte, the positive and negative currents alternately cycle 100 times. In this way, the surface nanostructure of the substrate surface is more uniform, and the adsorption effect of small molecules is better.

Moreover, in a third embodiment of the present disclosure, the substrate is made of any one of stainless steel, iron, glass and quartz. Therefore, a layer of precious metal needs to be plated on the surface of the substrate. Specifically, the operation of performing surface nanostructuring on the surface of the clean substrate includes: modifying gold nanoparticle or silver nanoparticle on the surface of the clean substrate, so that the surface of the clean substrate has a nanostructure with Raman spectrum enhancement effect to complete the surface nanostructuring. The preparation method is not limited in the present disclosure, and the preparation methods commonly used in the field can be used to prepare the nano-gold particles and the nano-silver particles, so that the surface enhancement effect is better.

Operation S30, inserting the surface nanostructured substrate in a test biological sample, and taking it out after adsorbing the substance to be detected, and then detecting Raman spectrum signal on the surface.

In this operation, the surface nanostructured substrate is directly inserted in the biological sample to absorb the small molecule substance to be detected. It is understandable that the time that the surface nanostructured substrate is placed in the biological sample to be detected should not be too long, otherwise it will adsorb protein macromolecules at the same time, which will affect the accuracy of the measurement results. Preferably, the time for the surface nanostructured substrate to be placed in the biological sample to be detected is around 1 second to 600 seconds, and the above-mentioned time can ensure that the protein is not easily adsorbed on the substrate.

It is understandable that the biological sample in the embodiments of the present disclosure can be liquid or solid, which is not limited. When the biological sample is liquid, the biological sample includes one of urine, saliva, tears, blood, serum, plasma, sweat, and semen. When the biological sample is solid, the biological sample includes melanoma or subcutaneous tissue. All of the above biological samples can be subjected to the surface-enhanced Raman spectroscopy.

In technical solutions of the present disclosure, the substrate can be directly inserted into the biological sample to adsorb small molecules in the biological sample by performing surface nanostructuring on the substrate. The movement of small molecules is faster than that of proteins, and the substrate performing the surface nanostructuring is also easier to adsorb small molecules. As such, the adsorption time of the substrate in the biological sample can be controlled, and the adsorption and sedimentation of protein can be avoided, thereby realizing rapid and reproducible detection of biological samples. The present disclosure provides a biological sample detection method based on surface-enhanced Raman spectroscopy, which can be directly inserted into the biological sample for detection. The biological sample does not need to be processed for protein removal, which simplifies the operation process and expands the scope of application. Thus, it is possible to avoid the influence of protein adsorption to enhance the sensitivity and stability of the substrate without pre-processing, and obtain stable and repeatable Raman signals of various biological samples in a short time, which can avoid the interference of various background signals in biological samples to the greatest extent.

Besides, the detection method of the present disclosure can effectively avoid the adsorption and sedimentation of proteins in biological samples, and can obtain reliable and highly reproducible signals of biological samples in a short time. The operating steps for detection are simple and suitable for zero-based personnel, which is expected to become a family medical testing technology.

The technical solution of the present disclosure will be further described in detail as follow in conjunction with specific embodiments. It should be understood that the following embodiments are only used to explain the present disclosure, and are not to limit the present disclosure.

### Example 1

(1) The silver needle used for Raman spectroscopy was repeatedly ultrasonically cleaned with acetone and ethanol three times, and then ultrasonically cleaned with clear water to obtain a clean substrate.

(2) The clean substrate was placed in the electrolytic cell and treated with a positive current +0.05 A for 5 seconds to etch the silver and some impurities on the surface of the silver needle; then treated with a negative current −0.05 A for 5 seconds to precipitate the silver in the electrolyte, the positive and negative currents alternately cycle 100 times, to build nanostructures on the surface of the silver needle to enhance Raman signals, and obtain the surface nanostructured substrate. The optical photo and the enlarged electron microscope photo are shown in FIG. 1. (a) is the optical picture of the silver needle, (b) is the electron microscope picture of the clean substrate, (c) is the electron microscope picture of the surface nanostructured substrate. The element analysis of the surface nanostructured substrate is shown in FIG. 2, and it can be seen that the element content is mainly silver.

(3) The surface nanostructured substrate was placed into 10 different saliva samples (the surface nanostructured substrate only needs to be in contact with the saliva), soaked for 180 s (3 minutes), taken out, and then placed in the matching sample stage to collect Raman signals. The integration time was 1 second. FIG. 3 shows the pictures of the above process, and FIG. 4 shows the detection results of the surface-enhanced Raman spectroscopy.

It can be seen from FIG. 1 that the surface of the surface nanostructured substrate is obviously different from the surface of the clean substrate, the surface of the surface nanostructured substrate is rougher, and the surface nanostructured substrate has stronger selective absorption of small molecules. It can be seen from FIG. 4 that the detection method of the embodiment of the present disclosure has a more significant Raman signal and excellent repeatability.

### Example 2

(1) The silver needle used for Raman spectroscopy was repeatedly ultrasonically cleaned with acetone and ethanol three times, and then ultrasonically cleaned with clear water to obtain a clean substrate.

(2) The clean substrate was placed into 0.1 mol/L nitric acid for 3 minutes, then taken out and cleaned with clear water for 3 times to obtain the surface nanostructured substrate.

(3) The surface nanostructured substrate was inserted into the urine (the surface nanostructured substrate touches the urine) for 180 s (3 minutes), taken out and placed in the matching sample stage to collect the Raman signal. The integration time was 3 seconds.

### Example 3

(1) The silver needle used for Raman spectroscopy was repeatedly ultrasonically cleaned with acetone and ethanol three times, and then ultrasonically cleaned with clear water to obtain a clean substrate.

(2) The clean substrate was placed into 1 mol/L nitric acid for 1 minute, then taken out and cleaned with clear water for 3 times to obtain the surface nanostructured substrate.

(3) The surface nanostructured substrate was inserted into the blood (the surface nanostructured substrate can be in contact with the blood) for 2 minutes, taken out and placed in the matching sample stage to collect the Raman signal. The integration time was 1 second.

### Example 4

(1) The stainless steel needle used for Raman spectroscopy was repeatedly ultrasonically cleaned with acetone and ethanol three times, and then ultrasonically cleaned with clear water to obtain a clean substrate.

(2) The nano-gold particle was prepared on the surface of the clean substrate to obtain the surface nanostructured substrate.

(3) The surface nanostructured substrate was inserted into the melanoma (the surface nanostructured substrate can be in contact with the melanoma) for 10 minutes, taken out and placed in the matching sample stage to collect the Raman signal. The integration time was 1 second.

Example 1 is taken as an example to illustrate the superiority of the detection method of present disclosure, the existing surface-enhanced Raman spectroscopy method for detecting biological samples is used as a comparative example. The specific operations of the existing surface-enhanced Raman spectroscopy method are dropping the saliva on the substrate, drying the substrate into a film, and placing the substrate in the matching sample stage to collect the Raman signal. The integration time is 1 second. FIG. 5 shows the detection process of the two methods, and FIG. 6 shows the electron micrographs of the two substrates after being removed from the saliva and the results of surface-enhanced Raman spectroscopy.

As can be seen from FIG. 6, after the substrate of Example 1 of the present disclosure is inserted into saliva, small molecules are uniformly adsorbed on the surface. However, in the comparative example, there are obvious macromolecule deposition on the surface, and the surface uniformity is obviously not as good as that of Example 1. Moreover, the intensity of the detection result of the surface-enhanced Raman spectroscopy of the comparative example is obviously inferior to that of Example 1 of the present disclosure, indicating that the detection method of the present disclosure is higher sensitivity.

In summary, the biological sample detection method based on surface-enhanced Raman spectroscopy proposed in the present disclosure simplifies the operation process and expands the scope of application, thereby avoiding the influence of protein adsorption to enhance the sensitivity and stability of the substrate without pre-treatment, and thus it is possible to obtain stable and repeatable Raman signals of various biological samples in a short time, which can avoid the interference of various background signals in biological samples to the greatest extent.

The above are only some optimization embodiments of the present disclosure, and do not limit the scope of the present disclosure thereto. Under the inventive concept of the present disclosure, equivalent structural transformations made according to the description and drawings of the present disclosure, or direct/indirect application in other related technical fields are included in the scope of the present disclosure.

What is claimed is:

1. A biological sample detection method based on surface-enhanced Raman spectroscopy, comprising following operations:
washing a substrate used for Raman spectroscopy to obtain a clean substrate;
performing surface nanostructuring on the clean substrate to make the clean substrate have a surface Raman enhancement effect, and ultrasonically cleaning the nanostructured substrate with clear water to obtain a surface nanostructured substrate; and
inserting the surface nanostructured substrate in a test biological sample, and taking it out after adsorbing the substance to be detected, and then detecting Raman spectrum signals on the surface.

2. The biological sample detection method based on surface-enhanced Raman spectroscopy of claim 1, wherein the substrate is made of any one of silver, gold and copper.

3. The biological sample detection method based on surface-enhanced Raman spectroscopy of claim 1, wherein the operation of performing surface nanostructuring on the clean substrate comprises:
etching a surface of the clean substrate with acid, so that the surface has a nanostructure with Raman spectrum enhancement effect to achieve the surface nanostructuring.

4. The biological sample detection method based on surface-enhanced Raman spectroscopy of claim 3, wherein an etching solution comprises any one of nitric acid, sulfuric acid and hydrochloric acid.

5. The biological sample detection method based on surface-enhanced Raman spectroscopy of claim 4, wherein the etching solution comprises nitric acid, and a concentration of the nitric acid is 0.1 mol/L to 1 mol/L.

6. The biological sample detection method based on surface-enhanced Raman spectroscopy of claim 1, wherein the operation of performing surface nanostructuring on the clean substrate comprises:
placing the clean substrate in an electrolytic cell, and alternately supplying positive and negative currents, so that the surface of the clean substrate has a nanostructure with Raman spectrum enhancement effect to achieve the surface nanostructuring.

7. The biological sample detection method based on surface-enhanced Raman spectroscopy of claim 1, wherein the substrate is made of any one of stainless steel, iron, glass and quartz,
the operation of performing surface nanostructuring on clean substrate comprises:
modifying gold nanoparticle or silver nanoparticle on the surface of the clean substrate, so that the surface of the clean substrate has a nanostructure with Raman spectrum enhancement effect to achieve the surface nanostructuring.

8. The biological sample detection method based on surface-enhanced Raman spectroscopy of claim 1, wherein the time for the surface nanostructured substrate to be placed in the test biological sample is around 1 second to 600 seconds.

9. The biological sample detection method based on surface-enhanced Raman spectroscopy of claim 1, wherein the biological sample comprises one of urine, saliva, tears, blood, serum, plasma, sweat, and semen.

10. The biological sample detection method based on surface-enhanced Raman spectroscopy of claim 1, wherein the biological sample comprises melanoma or subcutaneous tissue.
